(19) United States
(12) Patent Application Publication
(10) Pub. No.: US 2023/0381986 A1
(43) Pub. Date: Nov. 30, 2023

(54) MULTIPURPOSE UTILITY KNIFE SYSTEM

(71) Applicant: Robin Hayward, Mesa, AZ (US)

(72) Inventor: Robin Hayward, Mesa, AZ (US)

(21) Appl. No.: 18/202,475

(22) Filed: May 26, 2023

Related U.S. Application Data
(60) Provisional application No. 63/346,742, filed on May 27, 2022.

(51) Int. Cl. B26B 11/00; B26B 5/00; B25G 1/08

(52) U.S. Cl. CPC B26B 11/00; B26B 5/00; B25G 1/08

(57) ABSTRACT

A multipurpose utility knife system that can comprise a body having a function portion that can transition to a tang portion, the tang portion having at least one notch, a left side and a right side that is generally parallel to the left side, the left side and right side extending from a forward edge having a first thickness between the left side and the right side to an aft edge having a second thickness between the left side and the right side. A first connection port at the function portion. A second connection port that can transition to a tool body, the second connection port configured to detachably couple to the first connection port. A utility knife body.

### CROSS-REFERENCE TO RELATED APPLICATIONS

This application claims benefit from currently pending U.S. Provisional Application No. 63/346,742 titled “Multipurpose Utility Knife System” and having a filing date of May 27, 2022, all of which is incorporated by reference herein.

### FIELD OF THE INVENTION

The present specification relates to a multipurpose tool and more specifically to a multipurpose tool system that can be used in a razor blade handle.

### BACKGROUND OF THE INVENTION

Utility knifes known in the market are typically cutting tools that comprise of a cutting blade that is generally short and narrow with a durable housing or handle that holds the blade in place. Utility knives have been used for many years and different types of blades have been used for different applications. Most of these blades are either straight edge or have a serrated edge. These blades are held tight, but not permanently attached to, a metal or plastic housing the functions as a handle and usually includes a blade storage compartment within the housing. Most blades have at least two cut outs that are placed within the housing to secure the blades in place. Most utility knives have one useable cutting edge the protrudes from the housing. These blades are typically about 30 mm or less in length and about 1 mm wide. However, in some utility knives the length can extend significantly longer or short create a longer or shorter cutting edge.

A utility knife compared to other tools is usually only configured to cut and have no other function. The user is able to push and pull against the blade cutting in both directions and when not in use the blade is able to retract back into the utility knife' housing. In the retracted position the blade is shielded by the housing to protect the user while being stored or carried around. While providing many benefits, the traditional utility knife has many disadvantages. One disadvantage is that the utility knife only has one functional use. The traditional utility knife blade is very thin and cannot take any torsional or horizontal movements without the blade breaking. If a construction or industrial worker tries to use the blade for any other purpose than cutting, then the blade would break.

Therefore, there is a need for a multifunctional utility knife that allows the user to switch out the blade for other useful tools while using the same utility blade housing.

### BRIEF SUMMARY OF THE INVENTION

In embodiments a multipurpose utility knife system that can comprise a body having a function portion that can transition to a tang portion, the tang portion having at least one notch, a left side and a right side that is generally parallel to the left side, the left side and right side extending from a forward edge having a first thickness between the left side and the right side to an aft edge having a second thickness between the left side and the right side. A first connection port at the function portion. A second connection port that can transition to a tool body, the second connection port configured to detachably couple to the first connection port. A utility knife body.

The function portion can have a forward end wherein the connection port has a hole partially extending from the forward end toward the tang portion. The tool body can be a plurality of tools selected from the group comprising a Phillips-head screwdriver, a flat-head driver, a driver socket, a paint can lid opener, a wire trimmer, a scrapper, a wide scrapper, a hex nut wrench, a scriber, a right/left scrapper, and a saw blade.

The second connection port transitions to the tool body at a second transition and wherein the second transition can be a radius or chamfer. The first connection port can have at least one detent within the hole. The second connection port can have at least one ball and spring that mates with the at least one detent. The utility knife body can have at least one storage compartment that stores at least one tool body. The utility knife body can have at least on third connection port integrated within the body.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the multipurpose utility knife system in accordance to one, or more embodiments;

FIG. 2 is a top view of the multipurpose utility knife system in accordance to one, or more embodiments;

FIG. 3 is a side view of the multipurpose utility knife system in accordance to one, or more embodiments;

FIG. 4 is a front view of the multipurpose utility knife system in accordance to one, or more embodiments;

FIG. 5a-5i is an isometric view of different tool options for a multipurpose utility knife system in accordance to one, or more embodiments;

FIG. 6 is a side view of the multipurpose utility knife system with a storage compartment in accordance to one, or more embodiments;

FIG. 7 is a side view of the multipurpose utility knife system in its closed position with tool attached in accordance to one, or more embodiments; and

FIG. 8 is an isometric view of the multipurpose utility knife system in its open position without the tool attached in accordance to one, or more embodiments;

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

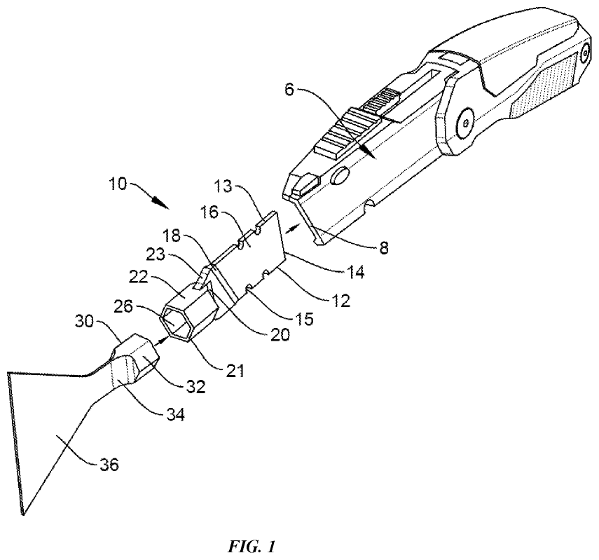

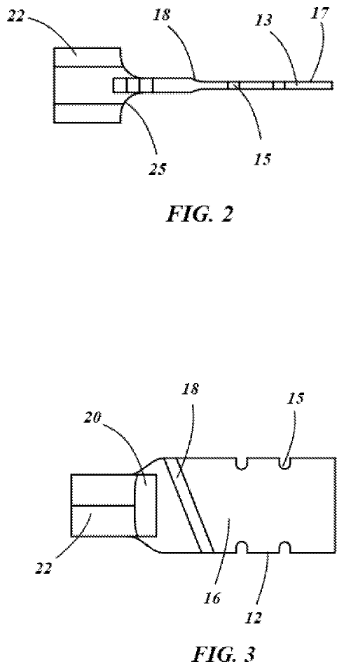

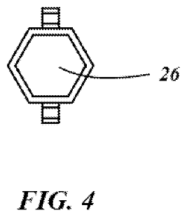

Referring initially to FIGS. 1-4, a multipurpose utility knife system is shown generally at 10. The multipurpose utility knife system 10 can comprise a body 12 having a function portion 22 that transitions to a tang portion 12, the tang portion having a least one notch 15, a left side 16 and a right side 17 that is generally parallel to the left side, the left side and the right side extending from a forward edge 21 having a first thickness 13 between the left side and the right side to an aft edge 14 having second thickness 23 between the left side and the right side. In other embodiments, the left side 16 and the right side 17 can have the same thickness or can have varying thicknesses. The aft edge 14 can be such as, for example a chamfer, radius, point, straight, in the general shape of the inside of a utility knife, or the like.

The tang portion 12 can have at least one notch 15 that can go through or partially through the first thickness 13. In the preferred embodiment the notch can match up to at least one utility knife notch within a utility knife 6 wherein the utility knife notches can keep the body within the utility knife. The tang portion 12 can be inserted into a utility knife body 6 encapsulating the first thickness 13 wherein the first thickness can be at least the same size or smaller than the slot 8 on the utility knife body 6. The first thickness 13 can be such as for example, between 0.005 inches to 0.125 inches, still more preferably between 0.010 inches to 0.100 inches, still more preferred 0.025 inches.

The first thickness 13 can have a first transition 18 to the second thickness 23 wherein the first transition can be such as, for example, a chamfer, radius, filet or the like. The first transition 18 can be angled to match the angle of the utility knife body 6 on the slot 8. The second thickness 23 can be such as for example, between 0.05 inches to 0.25 inches, still more preferably between 0.010 inches to 0.200 inches, still more preferred 0.125 inches. The difference between the first thickness 13 and the second thickness 23 adds strength to the body 12 for any compressive, shear or torsional load being applied to the body. The tang portion 12 can have a first transition 18 into the function portion 22 and in other embodiments the first transition can be omitted.

The first connection port 26 at the function portion 22 can have a second transition 20 wherein the second transition can be such as, for example, a chamfer, radius, filet or the like. The second transition 20 can be omitted in certain embodiments and the first connection port 26 and the function port 22 can be the same shape and size. The function portion 22 can extend from the second transition 20 towards the forward edge 21 wherein the function portion can be any suitable shape and size but in the preferred embodiment the function portion can be in the shape of such as, for example, a hexagon, circular, rectangular, square, or any other shape suitable. The function portion 22 can comprise a first connection port 26 wherein the first connection port can have a hole partially or fully extending from the forward end 21. The first connection port 26 can have locking hole (not shown) within the first connection port 21 that can lock a tool body 30 onto the second body. The first connection port 21 has at least one detent within the hole to help lock the tool body 30 within the first connection port. In certain embodiments, the first connection port 21 can have external or internal looking mechanism that locks the tool body 30 into the first connection port 21 such as, for example, a lock and lever, snap, latch or the like.

In embodiments, the tool body 30 can comprise a second connection port 32 wherein the second connection port can be configured to detachably coupled to the first connection port 26. The second connection port 32 can have a tool transition 34 into a tool body 36. The second connection port 32 can be such as, for example, a hexagon, circular, rectangular, square, or any other suitable shape and in the preferred embodiment can match the function port's 22 shape and size. In certain embodiments, the second connection port 32 can further comprise a spring and ball that can push against the locking hole to keep the tool body 30 attached onto the function portion 22. In embodiments, the second connection port transitions to the tool body at a second transition and wherein the second transition is a radius or chamfer. The tool body 30 can be a plurality of tools 36 selected from the group comprising a Phillips-head screwdriver, a flat-head driver, a driver socket, a paint can lid opener, a wire trimmer, a scrapper, a wide scrapper, a hex nut wrench, a scriber, a right/left scrapper, and a saw blade.

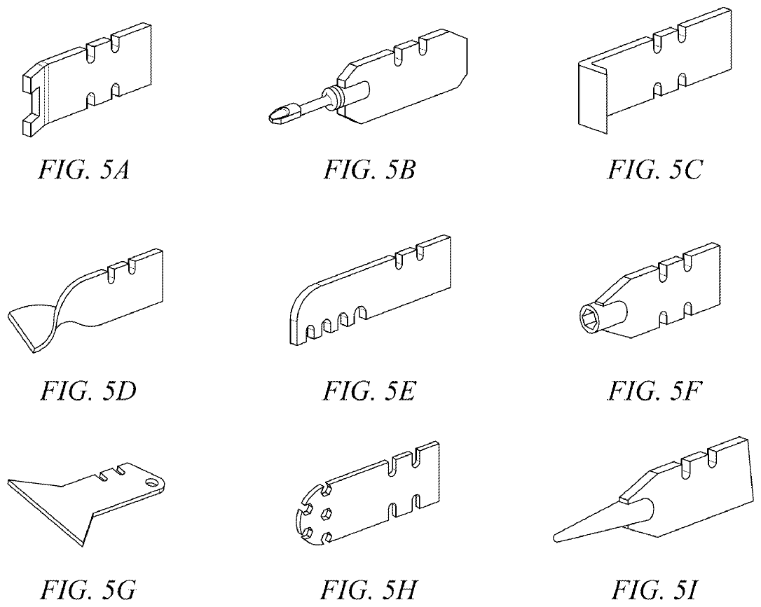

As shown in FIG. 5a-5i the tool body 30 can be a variety of different type of tools 36 used such as, for example, Phillips-head and flat-head driver, driver socket, paint can lid opener, wire trimmer, scrapper, wide scrapper, hex nut wrench, scriber, right/left scrapper, saw, blade, or the like. In certain embodiments, the tool body 30 can have at least one notch and can be directly inserted to and coupled to the utility knife body 6. The second body 22 can be omit and the tool body and the tang portion can be one single piece with at least one notch 15 within the tang portion.

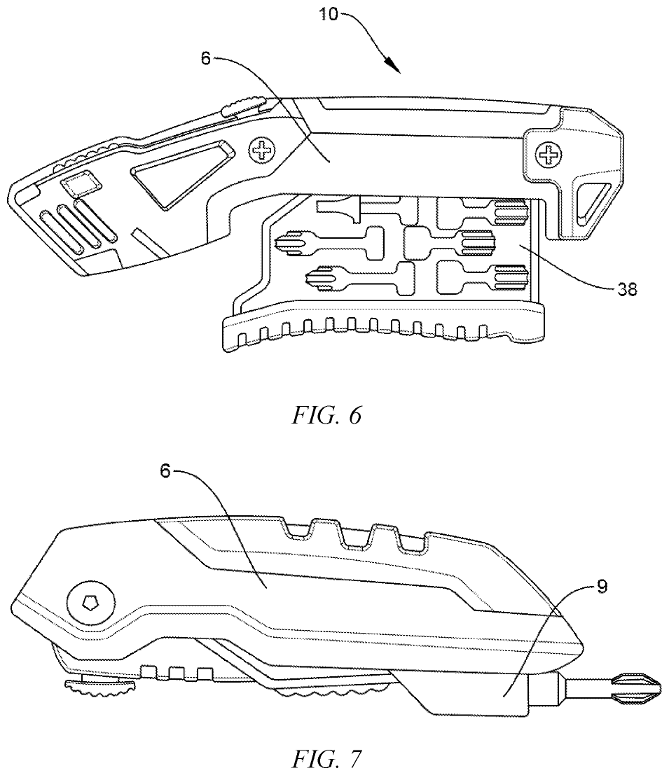

Referring to FIG. 6. a side view of the utility knife body 6 wherein the utility knife body can have a tool storage compartment 38 wherein the tool storage compartment can slide into the utility knife body and can have slots for each type of tool.

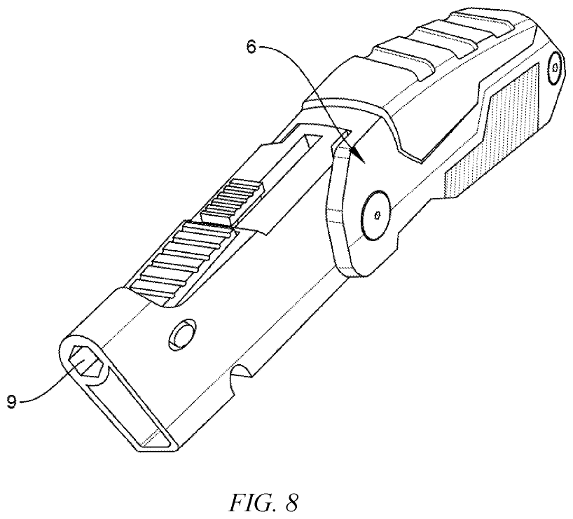

Referring to FIG. 7-8 another embodiment of a multipurpose utility knife system wherein the utility knife body 6 can comprise a connection port 9 wherein the connection port can protrude from the forward or aft end of the multipurpose tool body and can allow the tool body 30 to be inserted into the connection port 8 of the utility knife.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A multipurpose utility knife system comprising:
a body having a function portion that transitions to a tang portion, the tang portion having at least one notch, a left side and a right side that is generally parallel to the left side, the left side and right side extending from a forward edge having a first thickness between the left side and the right side to an aft edge having a second thickness between the left side and the right side;
a first connection port at the function portion;
a second connection port that transitions to a tool body, the second connection port configured to detachably couple to the first connection port; and
a utility knife body.

2. The multipurpose utility knife system according to claim 1, wherein the first thickness and the second thickness has a first transition wherein the first transition is chamfered or radiused to an increased thickness.

3. The multipurpose utility knife system according to claim 1, wherein the function portion has a forward end wherein the connection port has a hole partially extending from the forward end toward the tang portion.

4. The multipurpose utility knife system according to claim 1, wherein the tool body is a plurality of tools selected from the group comprising a Phillips-head screwdriver, a flat-head driver, a driver socket, a paint can lid opener, a wire trimmer, a scrapper, a wide scrapper, a hex nut wrench, a scriber, a right/left scrapper, and a saw blade.

5. The multipurpose utility knife system according to claim 1, wherein the second connection port transitions to the tool body at a second transition and wherein the second transition is a radius or chamfer.

6. The multipurpose utility knife system according to claim 1, wherein the first connection port has at least one detent within the hole.

7. The multipurpose utility knife system according to claim 6, wherein the second connection port has at least one ball and spring that mates with the at least one detent.

8. The multipurpose utility knife system according to claim 1, wherein the utility knife body has at least one storage compartment that stores at least one tool body.

9. The multipurpose utility knife system according to claim 1, wherein the utility knife body has at least on third connection port integrated within the body.
